(19) United States
(12) Patent Application Publication
(10) Pub. No.: US 2023/0061376 A1
(43) Pub. Date: Mar. 2, 2023

(54) Method for manufacturing nanocomposite separator for lithium secondary battery and nanocomposite separator for lithium secondary battery manufactured thereby

(71) Applicant: Korea Advanced Institute of Science and Technology, Daejeon (KR)

(72) Inventors: Sung Oh CHO, Daejeon (KR); Juhyuk LEE, Daejeon (KR); Sangyoon LEE, Daejeon (KR)

(73) Assignee: Korea Advanced Institute of Science and Technology, Daejeon (KR)

(21) Appl. No.: 17/827,433

(22) Filed: May 27, 2022

(30) Foreign Application Priority Data
Aug. 25, 2021 (KR) 10-2021-0112032
Mar. 4, 2022 (KR) 10-2022-0027950

(51) Int. Cl. H01M 50/446; H01M 50/403

(52) U.S. Cl. CPC H01M 50/446; H01M 50/403

(57) ABSTRACT

The present invention relates to a method for manufacturing a lithium secondary battery separator comprising the following steps: a step of surface-modifying inorganic particles using a coupling agent; a step of mixing the surface-modified inorganic particles with a polymer; and a step of irradiating an electron beam to the mixed inorganic particles and polymer. The method for manufacturing a lithium secondary battery separator provided in one aspect of the present invention has an effect that a lithium secondary battery separator having improved mechanical and thermal properties can be manufactured.

### CROSS-REFERENCE TO RELATED APPLICATIONS

This patent application claims the benefit of priority under 35 U.S.C. § 119 from Korean Patent Applications No. KR 10-2021-0112032 filed on Aug. 25, 2021 and No. KR 10-2022-0027950 filed on Mar. 4, 2022, the contents of which are incorporated herein by reference.

### BACKGROUND OF THE INVENTION

### Field of the Invention

The present invention relates to a method for manufacturing a lithium secondary battery separator and a lithium secondary battery separator manufactured thereby.

### Description of the Related Art

As consumer demands change due to digitalization and high performance of electronic products, the market demands are also changing to the development of high-capacity batteries by thinness, light weight and high energy density. In addition, in order to cope with future energy and environmental problems, the development of hybrid electric vehicles or fuel cell vehicles is actively progressing, and thus, there is a demand for increasing the size of batteries for vehicle power.

Secondary batteries including high energy density and large capacity lithium ion secondary batteries, lithium ion polymer batteries and supercapacitors (electric double layer capacitors and similar capacitors) must have a relatively high operating temperature range. Since the temperature rises when continuously used in a high-rate charge/discharge state, the separators used in these batteries are required to have higher heat resistance and thermal stability than those required for ordinary separators. In addition, the secondary batteries should have excellent battery characteristics such as high ionic conductivity that can cope with rapid charge and discharge and low temperature.

The separator is located between the anode and the cathode of the battery to insulate thereof, and to maintain the electrolyte to provide a path for ion conduction. In addition, the separator has a closing function to block the pores by melting a part of the separator in order to block the current when the temperature of the battery becomes too high.

If the temperature rises further and the separator melts, a large hole is formed and a short circuit occurs between the anode and the cathode. This temperature is called a “short circuit temperature”. In general, a separator should have a low shutdown temperature and a higher short circuit temperature. In the case of a polyethylene separator, when the battery generates abnormal heat, it contracts at 150° C. or more, exposing the electrode part, and there is a possibility of causing a short circuit. Therefore, it is very important to have both a closing function and heat resistance for high energy density and large size secondary batteries.

For example, in the case of Korean Patent Publication No. 10-2014-0112666, this problem is solved by proposing a porous separator for secondary batteries comprising a polyolefin substrate; a polyacrylonitrile nanofiber layer formed by electrospinning on one surface of the polyolefin substrate; and an inorganic coating layer formed by coating an inorganic material on one surface of the polyacrylonitrile nanofiber.

Also, in “TiO₂ ceramic-grafted polyethylene separators for enhanced thermostability and electrochemical performance of lithium-ion batteries” (Journal of Membrane Science, Volume 504, 15 Apr. 2016, Pages 97-103), a separator in which TiO₂ nanoparticles are coated on both sides of a polyolefin separator is proposed.

In the case of such a ceramic particle-coated separator, ceramic nanoparticles are coated on one or both sides of the polyolefin separator to improve heat resistance and mechanical properties compared to the conventional polyolefin separator.

However, in the case of this type of separator, the ceramic coating layer may peel off, and the ionic conductivity increases locally due to an imbalance in the coating thickness that occurs thereby, and there is a risk of overheating and leading to a serious accident.

In addition, there is also a disadvantage that it is not suitable to be applied to lithium secondary batteries of various shapes such as cylindrical or prismatic.

Accordingly, a new type of separator suitable for application to lithium secondary batteries is required.

### Prior Art References

Patent Reference: Korean Patent Publication No. 10-2014-0112666.

Non-Patent Reference: Journal of Membrane Science, Volume 504, 15 Apr. 2016, Pages 97-103.

### SUMMARY OF THE INVENTION

It is an object of the present invention to provide a novel lithium secondary battery separator having improved mechanical and thermal properties.

To achieve the above object, in one aspect of the present invention, the present invention provides a method for manufacturing a lithium secondary battery separator comprising the following steps:
a step of surface-modifying inorganic particles using a coupling agent;
a step of mixing the surface-modified inorganic particles with a polymer; and
a step of irradiating an electron beam to the mixed inorganic particles and polymer.

In another aspect of the present invention, the present invention provides a lithium secondary battery separator prepared by the above method.

In another aspect of the present invention, the present invention provides a lithium secondary battery containing the lithium secondary battery separator.

In another aspect of the present invention, the present invention provides a method for manufacturing a lithium secondary battery comprising a step of preparing a lithium secondary battery separator according to the method for manufacturing a lithium secondary battery separator.

### Advantageous Effects

The method for manufacturing a lithium secondary battery separator provided in one aspect of the present invention has an effect that a lithium secondary battery separator having improved mechanical and thermal properties can be manufactured.

In addition, the method of the present invention can overcome the disadvantages of the existing ceramic coating separator that the ceramic coating layer can be peeled off, and the ionic conductivity is locally increased due to an imbalance in the coating thickness, which can cause overheating and cause an accident, and has the advantage of being able to maintain the elasticity of the polymer used in the separator, so it is possible to manufacture more various shapes using the above method.

### BRIEF DESCRIPTION OF THE DRAWINGS

FIGS. 1A to 1B are sets of SEM images showing the cross-sections of the samples of an example and a comparative example of the present invention before electron beam irradiation,

FIGS. 2A to 2B are sets of SEM images showing the cross-sections of the samples of an example and a comparative example of the present invention after electron beam irradiation,

FIGS. 3A to 3D are sets of ATR-FTIR absorption spectra for the samples of examples and comparative examples of the present invention before and after electron beam irradiation,

FIGS. 4A to 4B are schematic diagrams showing the bond formation in an example and a comparative example of the present invention,

FIGS. 5A to 5B are sets of graphs showing the changes in mechanical properties of the samples of examples and comparative examples of the present invention according to electron beam irradiation,

FIGS. 6A to 6C are sets of graphs showing the stress-strain curves of the samples of examples and comparative examples of the present invention according to electron beam irradiation,

FIGS. 7A to 7B are sets of graphs showing the thermal properties of the samples of examples and comparative examples of the present invention measured by differential scanning calorimeter (DSC) according to electron beam irradiation.

FIGS. 8A to 8C are graph and a set of images showing the thermal shrinkage of the samples of examples and comparative examples of the present invention according to electron fluence of electron beam,

FIG. 9 is image showing the thermal shrinkage of the separators of example of the present invention with and without electron irradiation,

FIGS. 10A to 10B are SEM image showing the pores are well formed, and EDS mapping analysis images confirming that Al and O are evenly dispersed,

FIG. 11 is a graph showing the capacity evaluation results of a coin cell in which a commercial separator is applied and a coin cell in which a composite separator is applied for the samples of a preparative example 4,

FIGS. 12A to 12B are electrochemical performance of LIBs with LiCoO2/Li and different separators of Preparative example 4 and example 2.

### DETAILED DESCRIPTION OF THE INVENTION

Unless defined otherwise, all technical and scientific terms used in this specification have the same meaning as commonly understood by one of ordinary skill in the art to which this invention belongs. In general, the nomenclature used in this specification is those well known and commonly used in the art.

In one aspect of the present invention, the present invention provides a method for manufacturing a lithium secondary battery separator comprising the following steps:
a step of surface-modifying inorganic particles using a coupling agent;
a step of mixing the surface-modified inorganic particles with a polymer; and
a step of irradiating an electron beam to the mixed inorganic particles and polymer.

Hereinafter, the method for manufacturing a lithium secondary battery separator provided in one aspect of the present invention will be described in detail step by step.

First, the method for manufacturing a lithium secondary battery separator provided in one aspect of the present invention includes a step of surface-modifying inorganic particles using a coupling agent.

The inorganic particles can include a hydroxyl group.

The inorganic particles can form a hydrogen bond with a carbon atom of a polymer, which will be described later, by including a hydroxyl group.

In addition, since the inorganic particles include a hydroxyl group, oxygen radicals can be generated according to electron beam irradiation, which will be described later, and thus, a ketone functional group can be formed in a polymer described later.

As the hydroxyl group is abundant in the inorganic particle, the covalent bond density with the coupling agent increases, which may be advantageous for surface treatment, and thus the bonding force between the surface of the inorganic particle and the polymer described later can be improved.

The inorganic particles can be, for example, at least one selected from the group consisting of boehmite (AlO(OH)), beyerite (Al(OH)₃), goethite (FeOOH), and magnesium hydroxide (Mg(OH)₂).

The mechanical properties and thermal properties of the polymer described later can be improved by adding the inorganic particles.

The coupling agent can include at least one functional group selected from the group consisting of a vinyl group, an epoxy group, a methacryl group, an acryl group, an amino group ,a mercapto group and alkyl groups.

When polyethylene is selected as the polymer described later, the coupling agent can include a vinyl group. The vinyl group has excellent compatibility with polyethylene.

In one embodiment, the coupling agent can be a silane coupling agent. For example, the coupling agent can be at least one selected from the group consisting of vinyltrimethoxysilane, vinylethoxysilane, 3-(methacryloxypropyl) trimethoxysilane, 3-(methacryloxypropyl)triethoxysilane, 3-mercaptopropyltrimethoxysilane, methyltrimethoxy silane, octyltrimethoxysilane and octadecyltrimethoxysilane, but not always limited thereto.

The inorganic particles can be surface-modified by the coupling agent to prevent aggregation between the inorganic particles, and accordingly, dispersion properties in a polymer matrix described later can be improved.

Next, the method for manufacturing a lithium secondary battery separator provided in one aspect of the present invention includes a step of mixing the surface-modified inorganic particles with a polymer.

The polymer can be an aliphatic polymer.

In more detail, the polymer can be a polyolefin-based polymer.

The polymer can be at least one selected from the group consisting of polyethylene and polyolefin, but not always limited thereto.

Next, the method for manufacturing a lithium secondary battery separator provided in one aspect of the present invention includes a step of irradiating an electron beam to the mixed inorganic particles and polymer.

In the above step, a ketone functional group can be formed in the polymer by electron beam irradiation.

In the above step, an ester bond can be formed between the polymer and the inorganic particle by electron beam irradiation.

More specifically, an ester bond can be formed between a ketone functional group of the polymer and a vinyl group of the coupling agent. At this time, oxygen radicals generated by electron beam irradiation can be used.

In the above step, a covalent bond can be formed between the polymer and the inorganic particle by electron beam irradiation.

More specifically, a covalent bond can be formed between a vinyl group of the coupling agent and carbon in the polymer chain.

The electron beam can be irradiated with an electron fluence of 5×10¹³ cm⁻² to 1×10¹⁵ cm⁻², preferably 6×10¹³ cm⁻² to 9×10¹⁴ cm⁻², more preferably 8×10¹³ cm⁻² to 8×10¹⁴ cm⁻².

When the electron fluence of the electron beam is less than 5×10¹³ cm⁻², the electron beam irradiation effect may be insignificant, and thus bonding formation can be insufficient.

In addition, when the electron fluence of the electron beam exceeds 1×10¹⁵ cm⁻², bond cleavage by electron beam irradiation dominates rather than additional bond formation by electron beam irradiation, and thus mechanical properties can be rather deteriorated.

In another aspect of the present invention, the present invention provides a lithium secondary battery separator prepared by the above method.

For the lithium secondary battery separator provided in another aspect of the present invention, all of the contents described in the above-mentioned method for manufacturing a lithium secondary battery separator can be applied.

The lithium secondary battery separator provided in another aspect of the present invention can be in a form in which inorganic particles surface-modified using a coupling agent and a polymer are complexed.

Compared to a polymer separator or a separator in which a polymer and non-surface-modified inorganic particles are complexed, this type of separator can have significantly improved mechanical and thermal properties.

Unlike the conventional separator in which inorganic particles are coated on one or both surfaces of a polymer, the separator of the present invention can be in a form in which inorganic particles are uniformly dispersed in a polymer matrix.

Accordingly, it is possible to overcome the disadvantages of the conventional separator that the coating layer may be peeled off, which may cause an accident due to overheating by the local increase in ionic conductivity caused by an imbalance in the coating thickness.

In addition, it is possible to maintain the elasticity of the polymer used in the separator, so it can be applied to more various shapes.

In the separator, an ester bond can exist between the polymer and the inorganic particle.

In addition, a covalent bond can exist between the polymer and the inorganic particle in the separator.

In another aspect of the present invention, the present invention provides a lithium secondary battery containing the lithium secondary battery separator.

In another aspect of the present invention, the present invention provides a method for manufacturing a lithium secondary battery comprising a step of preparing a lithium secondary battery separator according to the method for manufacturing a lithium secondary battery separator.

For the lithium secondary battery and the method for manufacturing thereof, all of the contents described in the above-mentioned method for manufacturing a lithium secondary battery separator and the lithium secondary battery can be applied.

In addition, since all conventionally used components and processes can be applied to other components of the lithium secondary battery and other processes of the method for manufacturing a lithium secondary battery, a separate description is not provided.

Hereinafter, the present invention will be described in detail by the following examples and experimental examples. The scope of the present invention is not limited to specific embodiments, and should be construed according to the appended claims. In addition, those skilled in the art may understand that many modifications and variations are possible without departing from the scope of the present invention.

### Preparative Example 1

A high density polyethylene (HDPE) of grade F920A (melt flow index: 190° C. / 2.16 kg 1.0 dg/min; density: 0.956 g/cm³) was prepared.

An HDPE film was prepared from this using a BA-11 twin screw extruder equipped with a film dispensing device.

The loading level of the film was set to 8 weight%, the screw of the extruder was rotated at 400 rpm during film production, and the temperature profile from the hopper to the die was set to 180-185-190-190-190-200-210-220° C.

The exit cross-sectional area of the T-die was 100 mm × 0.5 mm, and the temperature of the chill roll was set at 80° C. The film thickness was adjusted to 30 µm by regulating the rotational speed of the roller in the film dispensing device, and the stretching ratio (ratio between the initial cross-section and the final cross-section of the cast film) was 25.5. The chill roll adjacent to the T-die provided lateral restraint during drawing.

### Preparative Example 2

Boehmite nanoparticles in the form of dry powder having an average particle size of 20 nm were prepared.

The particles were added to ethanol and dispersed by ultrasonic treatment, and after mixing with the same high-density polyethylene as prepared in Preparative Example 1, a BA/HDPE film in which the high-density polyethylene and the boehmite nanoparticles were complexed in the same manner as in Preparative Example 1 was prepared.

### Preparative Example 3

Vinyltrimethoxysilane (VMTS, 98% purity, CAS No. 2768-02-7) was prepared.

This vinyltrimethoxysilane was dissolved in diluted ethanol, and at this time, the content of vinyltrimethoxysilane was 5 wt%.

The pH of the solution in which vinyltrimethoxysilane was dissolved was adjusted to 4.0 using acetic acid, and then stirred for 1 hour to induce hydrolysis of vinyltrimethoxysilane.

Then, the same boehmite nanoparticles prepared in Preparative Example 2 were added to the vinyltrimethoxysilane solution, and the resulting solution was refluxed for 24 hours while vigorously stirring. The treated boehmite nanoparticles (BA) were filtered, washed, and placed in a drying oven at 80° C. for 24 hours.

A vBA/HDPE film in which the high-density polyethylene and the boehmite nanoparticles were complexed in the same manner as in Preparative Example 1 was prepared.

### Preparative Example 4

In order to manufacture a separator in which pores are formed so that it can be used in actual secondary battery production, a separator was prepared as follows.

A mixture of surface-modified nanoparticles (vBA), high-density polyethylene (HDPE) and paraffin oil was prepared. At this time, the content of nanoparticles was 0.75 wt%, the content of polyethylene was 29.25 wt%, and the content of paraffin oil was 70 wt%. The final separator containing 2.5% of nanoparticles was prepared after oil extraction

The mixture was put into a twin-screw extruder at a rate of 7 g/min using a tubing pump in a 100° C. stirring environment (500 rpm) for homogenization, and after the melt stirring process in the extruder, a 0.5 mm thick gel-film was prepared in the same manner as in Preparative Example 1.

Then, the gel-film was stretched 25 times at 90° C., and paraffin oil was extracted to prepare a 20 µm-thick composite separator.

### Comparative Example 1

The film of Preparative Example 1 was uniformly irradiated with an electron beam at a pressure of 10⁻⁶ torr using a thermionic electron gun equipped with a tantalum anode. The energy and current density of the electron beam were set to 50 keV and 0.5 µA cm⁻², respectively.

The electron beam was irradiated in a circular shape with a diameter of 6 cm.

The electron fluence delivered to the film ranged from 1×10¹⁴ cm⁻² to 1×10¹⁵ cm⁻², which corresponds to the irradiation time ranging from 0.5 to 5 minutes and the absorbed dose ranging from 50 kGy to 500 kGy.

### Comparative Example 2

The film of Preparative Example 2 was irradiated with an electron beam in the same manner as in Comparative Example 1.

### Example 1

The film of Preparative Example 3 was irradiated with an electron beam in the same manner as in Comparative Example 1.

### Example 2

The separator of Preparative Example 4 was irradiated with an electron beam in the same manner as in Comparative Example 1.

### Experimental Example 1 Analysis of Film Morphology

In order to investigate the shape of the cross-section, the films of Preparative Example 2, Preparative Example 3, Comparative Example 2, and Example 1 were crushed in liquid nitrogen, and the fractured surface was analyzed with a scanning electron microscope (SEM, SU5000, Hitachi, Tokyo, Japan).

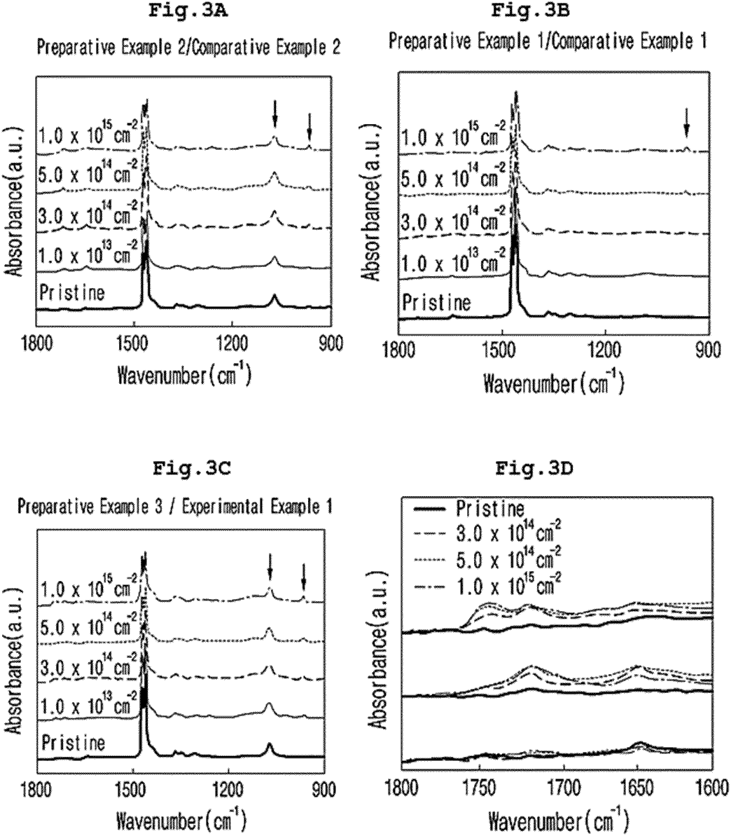

FIGS. 1A to 1B shows low-temperature cracking cross-sectional images of the films of Preparative Examples 2 (FIG. 1A) and 3 (FIG. 1B).

When using boehmite not surface-modified as in Preparative Example 2, it was confirmed that the nano-pillar had a high surface energy, so that the nanoparticles were agglomerated to form micrometer-sized particles (FIG. 1A). The cavities indicated by arrows show that the boehmite nanoparticles, which were originally located in the cavities, were displaced due to poor adhesion to the HDPE matrix.

On the other hand, when using boehmite nanoparticles surface-modified with vinyltrimethoxysilane as in Preparative Example 3, it was difficult to observe agglomerated nanoparticle mass (FIG. 1B). That is, such surface modification of nanoparticles can improve the dispersion properties of the nanoparticles and reduce the size and number of the cavities in the polymer matrix.

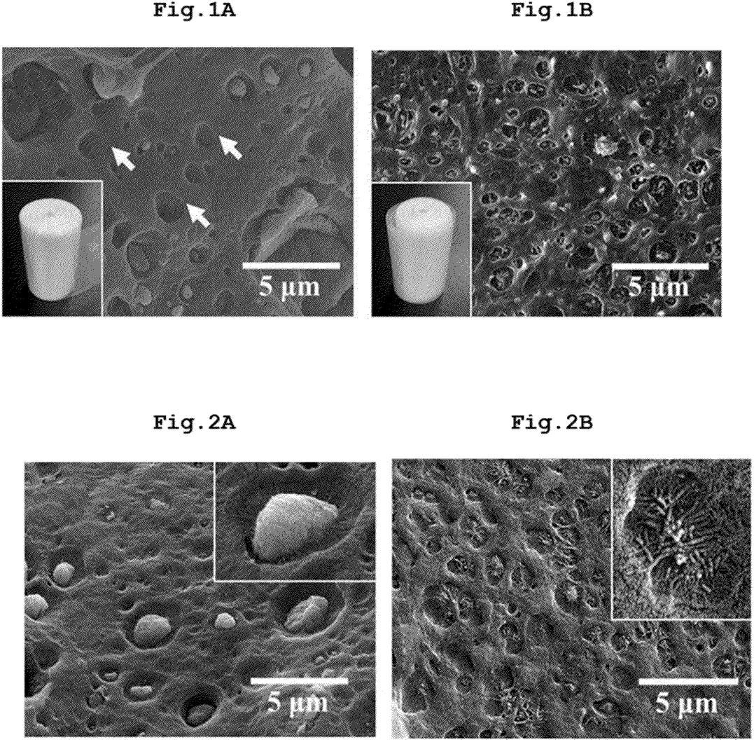

FIGS. 2A to 2B shows low-temperature cracking cross-sectional images of the films of Comparative Example 2 (FIG. 2A) and Example 1 (FIG. 2B) after irradiation with an electron beam.

As the electron beam was irradiated, it was confirmed that the interfacial adhesion of both the films of Comparative Example 2 and Example 1 between the nanoparticles and the polymer was greatly improved.

The boehmite nanoparticles (BA) had much less tendency to fall out of the cavity, and in particular, the surface-modified needle-shaped boehmite nanoparticles (vBA) adhered more strongly to the polymer matrix.

That is, as shown in FIGS. 1A, 1B and 2A, 2B, it was confirmed that the adhesion of the nanoparticles to the polymer matrix was improved according to the electron beam irradiation, and in the case of the surface-modified boehmite nanoparticles (vBA), the adhesion was further improved.

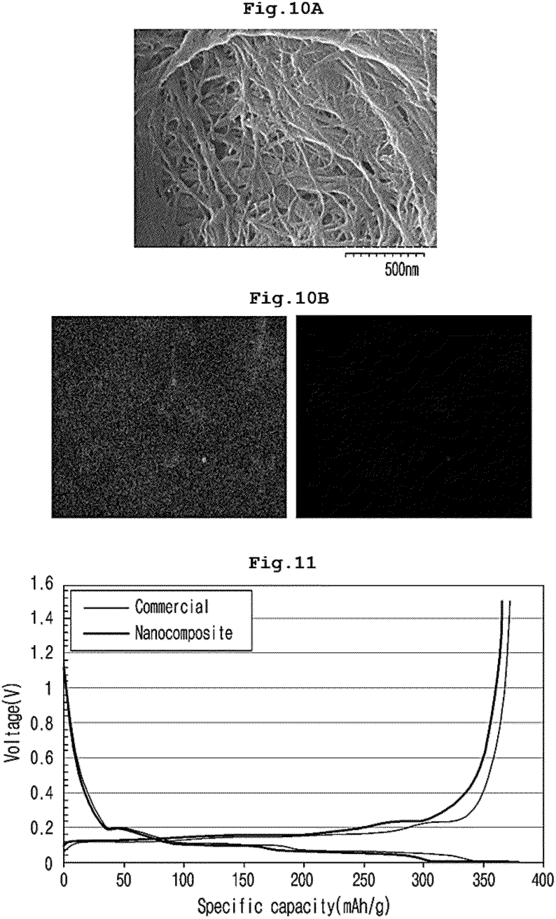

FIG. 10A is SEM image showing the surface of preparative example 4 in which pores are well formed, and FIG. 10B is EDS mapping analysis images of preparative example 4 confirming that Al and O are evenly dispersed.

### Experimental Example 2 Analysis of ATR-FTIR Spectra

In order to evaluate the effect of surface modification (silanization) and electron beam irradiation of nanoparticles, FTIR spectra of the films of Preparative Examples 1 to 3, Comparative Examples 1 and 2 and Example 1 were obtained using a Fourier transform infrared spectrometer (FTIR, Nicolet iS50, Thermo Fisher Scientific Instrument, Waltham, MA, USA) in attenuated total reflection (ATR) mode.

FIGS. 3A to 3C shows ATR-FTIR spectra of HDPE films (Preparative Example 1 and Comparative Example 1), BA/HDPE films (Preparative Example 2 and Comparative Example 2) and vBA/HDPE films (Preparative Example 3 and Example 1) before and after electron beam irradiation.

Peaks at 1463 cm⁻¹ and 1473 cm⁻¹ corresponding to CH₂ rocking vibration were found in all spectra, and these CH₂ peaks were reduced by electron beam irradiation, and a new peak corresponding to trans-vinylene C═C bending was generated at 966 cm⁻¹.

The decrease in these peaks indicates dissociation of chemical bonds and generation of radicals, whereas the formation of a new peak may be due to recombination of these radicals through cross-linking.

When BA nano-pillars were added as in Preparative Example 2 and Comparative Example 2, an Al-O peak was formed at 1070 cm⁻¹ as shown in FIG. 3B.

In addition, when these BA nanoparticles were surface-treated, it was relatively difficult to confirm the effect of surface modification in the ATR-FTIR spectra of vBA/HDPE (FIG. 3C) because the surface portion of the nanoparticles affected by the surface treatment process was limited.

However, slight changes could be confirmed, for example, the Al-O peak became wider as the BA nano-pillars were surface-treated, which is because Si—O and Si—O—Si bonds were easily formed on the surface of vBA.

In the silanization process, silanol was converted to siloxane by condensation, and the remainder was crosslinked by electron beam irradiation to form a stronger siloxane chain.

FIG. 3D shows the ATR-FTIR spectra of the films irradiated with an electron beam.

The spectra all showed C═O peaks at 1745, 1720 and 1645 cm⁻¹. EB irradiation of BA can generate oxygen radicals that can react with polyethylene to form C═O bonds.

In the case of BA/HDPE, the hydroxyl group on the BA surface formed a hydrogen bond with the ketone group of HDPE. In the case of vBA/HDPE, the vinyl functional group found in VTMS formed an ester bond with HDPE using oxygen radicals generated during the irradiation. The formation of the ester bond corresponds to a peak at 1745 cm⁻¹ in the ATR-FTIR spectra of vBA/HDPE.

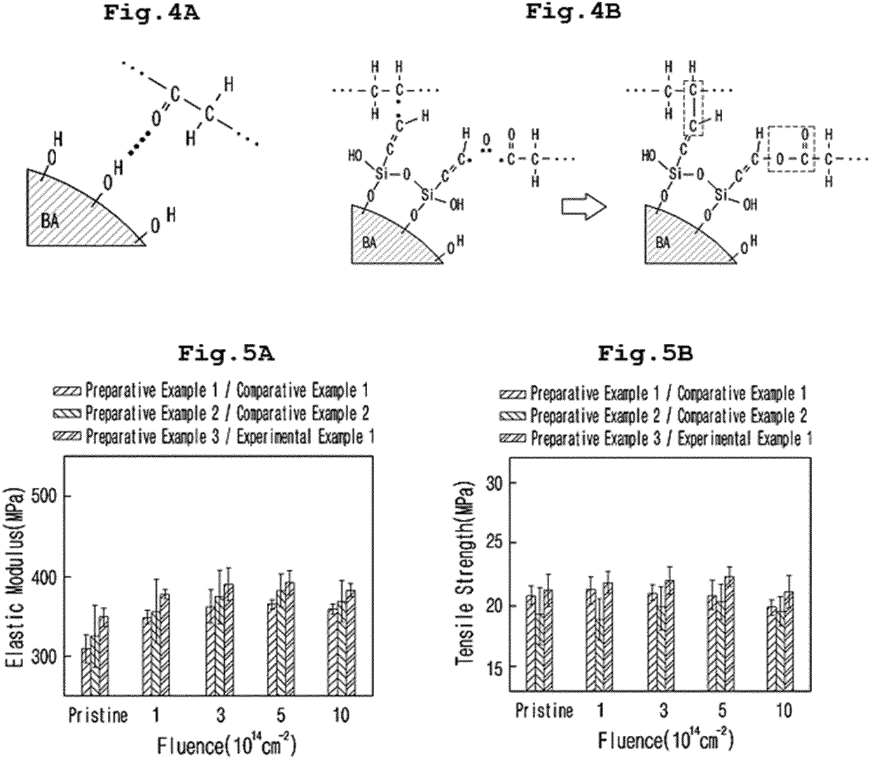

In the formation of such an ester bond, it can be inferred that a C-C bond is also formed by radical grafting. That is, the vinyl group on the surface of the vBA particle can form a covalent bond with the HDPE chain through electron beam induced radical grafting. The radical formation process of HDPE by electron beam irradiation and the bond formation process between the nanoparticle surface and the HDPE matrix can be understood through FIGS. 4A to 4D.

### Experimental Example 3 Measurement of Mechanical Properties

The elastic modulus, yield strength and elongation at break of the samples (100 mm × 20 mm) were measured at room temperature with a load of 5 kN according to ASTM D882-18 standard using a universal testing machine (Instron5848, Instron, Norwood, MA, USA). The gauge length was set at 30 mm and the crosshead speed was set at 50 mm/min. The sample was stretched along the longitudinal direction, and the modulus of elasticity was calculated by determining the slope of the tangent line in the initial linear part of the force-elongation curve.

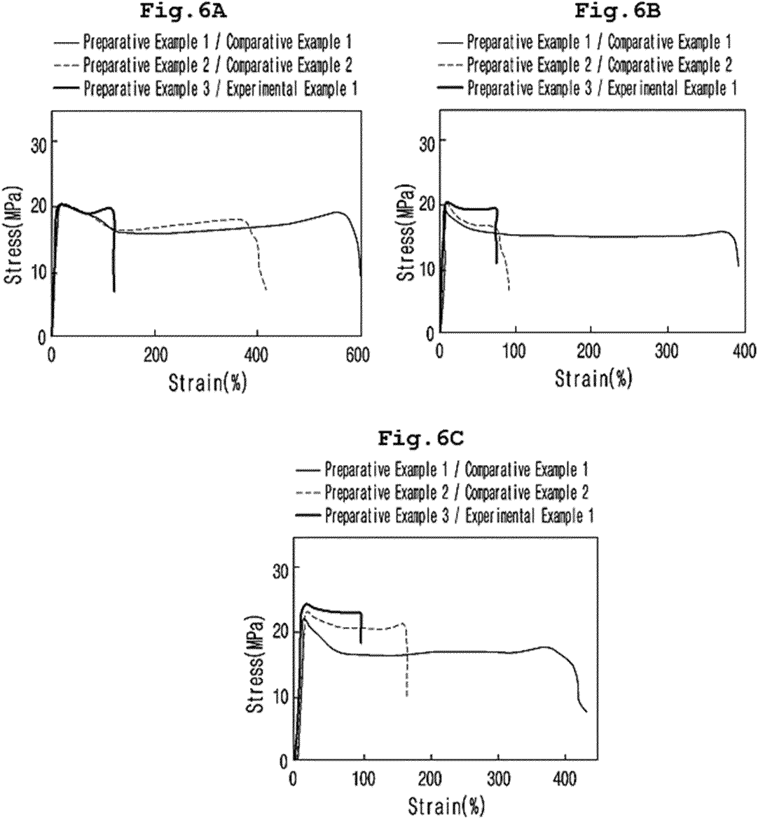

The effect of electron beam irradiation on the mechanical properties of unmodified BA and modified BA can be confirmed through FIGS. 5A to 5B and 6A to 6C. It was confirmed that the elastic modulus was significantly increased when BA nanoparticles were added to the pure HDPE film. The BA nanoparticles enhanced the strength of the polymer to resist expansion by limiting the chain mobility of the polymer. In particular, the improvement of the elastic modulus of the modified BA was much greater than that of the unmodified BA. That is, since the ability to limit the chain mobility was significantly reduced when the nanopillars were aggregated, it was confirmed that the elastic modulus was further improved when the aggregation of the nanopillars was prevented by modifying the surface.

In addition, electron beam irradiation could serve to further limit the chain mobility by crosslinking.

However, when the electron beam was irradiated with an electron fluence higher than 5.0 × 10¹⁴ cm⁻², more chain cleavage was induced than cross-linking in HDPE.

Therefore, as shown in FIG. 5A, mechanical properties were initially improved as the film was irradiated with an electron beam, but the mechanical properties were decreased after a certain point.

Among the films, vBA/HDPE could additionally provide another type of the chain mobility limitation due to the irradiation-induced bonding generated between the vinyl radicals of VTMS and HDPE, and thus the elastic modulus was less decreased at high electron fluence.

In addition, vBA/HDPE exhibited the highest yield strength among the three samples. Due to the high interfacial adhesion of the modified BA in HDPE, the stress could be effectively transferred from the HDPE matrix to the nanopillars. However, it could be observed that pure HDPE had better yield strength than that of BA/HDPE. Nanoparticle agglomerates, which are relatively abundant in BA/HDPE, could produce weak spots that could cause localization of stress and reduce the overall strength of the film.

By the irradiation-induced crosslinking, which limits chain mobility at low doses, the elongation at break was reduced in all samples at the beginning of electron beam irradiation. As chain cleavage became more dominant at higher doses, the effect of crosslinking disappeared, and the elongation properties were no longer reduced. As mentioned earlier, the BA nanopillars provided additional chain mobility limitations, so the films with BA nanopillars were much harder than the pure HDPE films. However, BA/HDPE showed the lowest elongation at break among the three films because the aggregation of nanoparticles causes stress localization, and the local stress leads to premature rupture.

### Experimental Example 4 Measurement of Thermal Properties

Thermal properties of the films were analyzed using a differential scanning calorimeter (DSC, DSC 214 polyma, Netzsch, Selb, Germany) at a constant heating rate of 10° C. per minute under a constant nitrogen flow. The films were heated to 25° C. to 200° C., and after cooling to room temperature, the films were heated to 200° C. for a second heating cycle.

The degree of crystallinity (Xc) was calculated using mathematical formula 1 below.

$${X}_{c} = \left(Δ {H}_{m} / Δ ° {H}_{m}\right) \times 100$$

Herein, ΔHₘ and Δ°Hₘ are the melting enthalpy of PE and the melting enthalpy of perfectly crystalline PE (293 J/g), respectively.

Thermal shrinkage test was performed by measuring the dimensional changes of the film after putting the film in an oven at 135° C. for 0.5 hours. Thermal shrinkage was calculated as the percentage change in area after heat exposure.

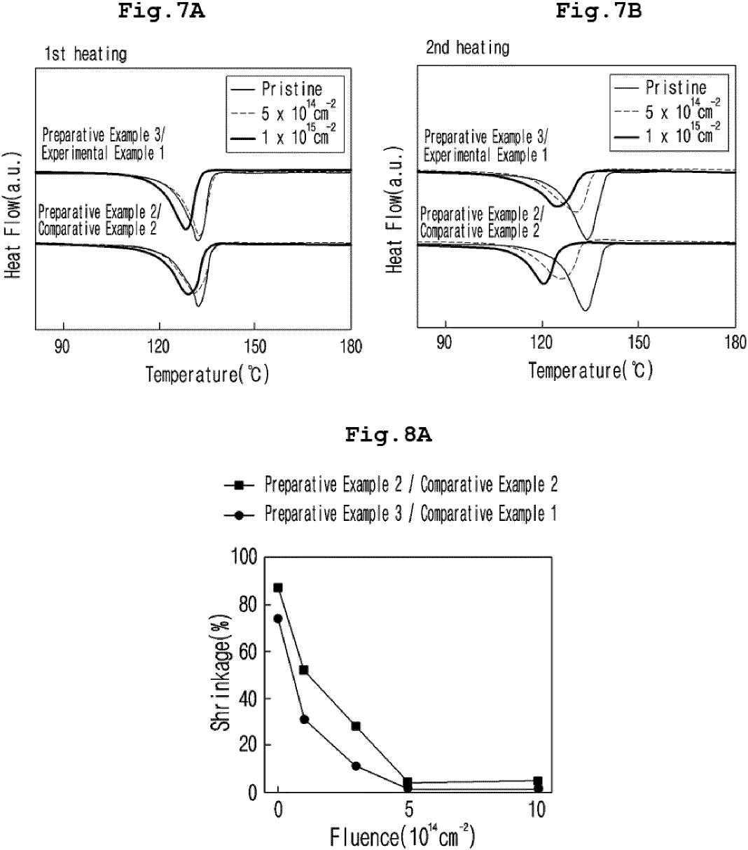

In order to evaluate the melting behavior of the sample before and after electron beam irradiation, DSC measurement values were collected in the first heating cycle and in the second heating cycle after recrystallization, and are shown in FIGS. 7A to 7B and Table 1 below.

Table 1

| Film | Electron beam irradiation (× 10¹⁴ cm⁻²) | First heating | | | Second heating | | |
|---|---|---|---|---|---|---|---|
| | | Tm(°C) | ΔHm | Xc(%) | Tm(°C) | ΔHm | Xc(%) |
| BA/HDPE (Preparative Example 2) | X | 131.9 | 152.92 | 52.1 | 132.9 | 169.61 | 57.8 |
| | 5 | 131.1 | 150.81 | 51.4 | 125.3 | 140.96 | 48.1 |
| | 10 | 128.9 | 149.28 | 50.9 | 119.9 | 126.85 | 43.2 |
| vBA/HDPE (Preparative Example 3) | X | 132.1 | 153.2 | 52.2 | 133.3 | 173.35 | 59.1 |
| | 5 | 132.6 | 155.5 | 53.1 | 129.8 | 140.64 | 48.0 |
| | 10 | 128.3 | 150.1 | 51.2 | 124.2 | 123.32 | 42.1 |

The melting temperature was determined by the peak position in the DSC curve during the heating cycle, and it was found that the melting temperature of all the films was decreased after electron beam irradiation. Since the melting temperature greatly depends on the crystal state and size, the decrease in the melting temperature may be due to the deterioration of the microcrystals of the film due to the electron beam irradiation.

It was confirmed that the vBA/HDPE film was less affected by electron beam irradiation in terms of melting temperature than the BA/HDPE film. This was due to the additional irradiation-induced crosslinking occurring between the vBA nanoparticles and the HDPE matrix. In the second heating cycle, DSC measurements showed that the melting temperature of the irradiated film was reduced by the initial heating process. These results indicate that the degree of crosslinking of the sample after electron beam irradiation was actually higher, since crosslinking hinders the recrystallization and lowers the melting temperature.

Thermal shrinkage is closely related to the thermal stability of polymer films, and reducing thermal shrinkage is important in applications requiring high thermal stability, such as lithium secondary battery separators. The separator must maintain structural integrity at high temperatures to prevent internal short circuits. Therefore, even if the operating temperature of the lithium secondary battery does not exceed 60° C., a malfunction of the secondary battery may occur, so a temperature exceeding 60° C. must be considered.

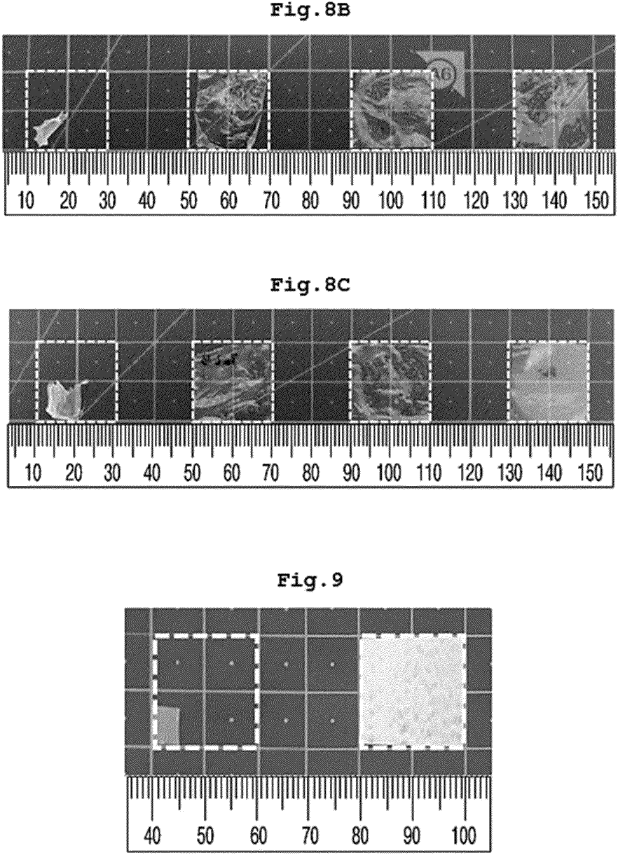

FIGS. 8A to 8C shows the thermal shrinkage of the film as a function of electron fluence. In all of the films before electron beam irradiation, severe thermal shrinkage occurred in which 70% or more of the surface area was lost after being placed in an oven at 135° C. for 0.5 hours. Electron beam irradiation was able to significantly reduce the thermal shrinkage of all films, since irradiation-induced crosslinking greatly limits the chain mobility of the polymer to prevent thermal shrinkage. In the case of the vBA/HDPE film, the thermal shrinkage of the film could be most suppressed because additional crosslinking could occur between the vBA and the polymer matrix.

FIG. 9 shows the thermal shrinkage of the separator with(fluence of 5x10⁴cm⁻²;right) and without(left) electron irradiation. The irradiated vBA/HDPE separator did not show shrinkage in an oven at 135° C. for 0.5 hours, which is consistent with the results of films.

### Experimental Example 5 Measurement of Electrochemical Performance

When the composite separator according to Preparative Example 4 was applied to a coin cell, whether the battery capacity was lowered was compared with a coin cell to which a commercial separator (manufactured by Welcos) was applied. After the coin cell was prepared and stabilized by aging at 25° C. for 12 hours, the cell was activated by charging/discharging thereof with a current of 0.1 C. Then, the cell was charged/discharged with a current of 0.5 C, and the capacity at this time was used as a reference.

The coin cell was charged up to 0.005 V with a current of 0.5 C by a constant current/constant voltage method, and a current of 0.05 C was set as a termination condition. Discharging was performed by setting a voltage of 1.5 V as a termination condition with a current of 0.5 C, similar to charging in a constant current method.

The discharge capacity of the coin cell to which a commercial separator was applied was 372 mAh/g, which was consistent with the capacity of natural graphite used for evaluation. The discharge capacity of the coin cell to which a composite separator was applied was 365 mAh/g, which was measured to be 98.1% of that of a commercial separator. These results are shown in FIG. 11.

The separator prepared according to Preparative Example 4 of the present invention has enhanced heat resistance and mechanical properties by the added inorganic material, and when applied to an actual secondary battery, it showed a discharge capacity equivalent to that of a commercial separator, and it was confirmed that there was no deterioration in battery characteristics due to inorganic substances.

Therefore, it is expected that the manufacturing method of the present invention can be utilized as an effective method for manufacturing a separator with improved thermal resistance and mechanical properties without deterioration of battery performance.

The electrochemical performances of the separators according to Preparative Example 4 and Example 2 were analyzed by assembling CR2032 coin half-cells. The separator was sandwiched between a lithium metal anode and a LiCoO2 cathode and soaked with the electrolyte of 1 M LiPF6 in EC/DEC/DMC (1:1:1, by volume).

After preparing a coin cell and aging it at 25° C. for 12 hours to stabilize it, the cell was activated by charging and discharging with a current of 0.1 C in the first cycle.

Cells were charged by a voltage range from 3.0 V to 4.2 V at a constant charging current density of 0.5 C and discharging at several current densities from 0.2 C to 4.0 C.

Cycling performance and coulombic efficiencies were examined at charge/discharge current density of 0.5 C/0.5 C for 50 cycles

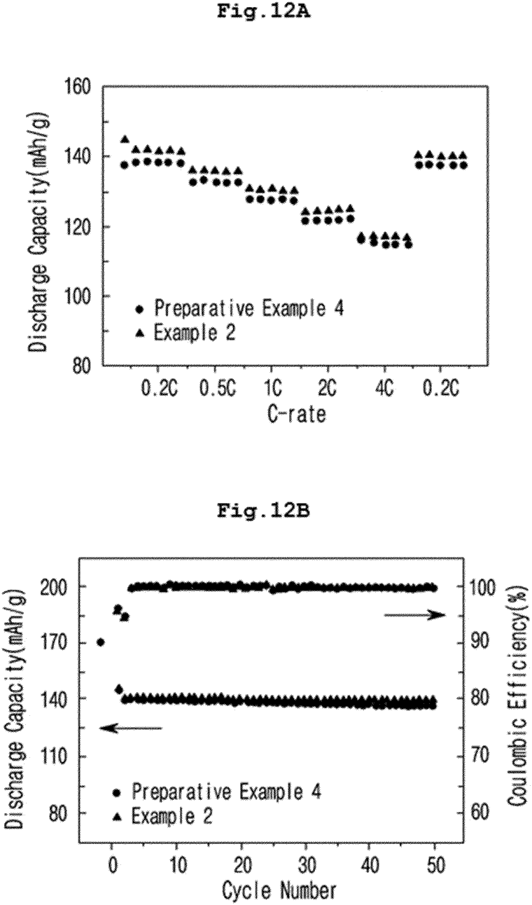

FIGS. 12A to 12B shows the electrochemical performance of cells with vBA/HDPE composite separator without and with electron beam irradiation respectively. vBA/HDPE composite separator achieved excellent cycle capacity with a great coulombic efficiency of 99.7% over 50 cycles.

Therefore, it is expected that the manufacturing method of the present invention can be utilized as an effective method for manufacturing a separator with improved thermal resistance and mechanical properties without deterioration of battery performance.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

What is claimed is:

1. A method for manufacturing a lithium secondary battery separator comprising the following steps:
a step of surface-modifying inorganic particles using a coupling agent;
a step of mixing the surface-modified inorganic particles with a polymer; and
a step of irradiating an electron beam to the mixed inorganic particles and polymer.

2. The method for manufacturing a lithium secondary battery separator according to claim 1, wherein the inorganic particles contain a hydroxyl group.

3. The method for manufacturing a lithium secondary battery separator according to claim 1, wherein the inorganic particles are at least one selected from the group consisting of boehmite (A10(OH)), beyerite (Al(OH)₃), goethite (FeOOH) and magnesium hydroxide (Mg(OH)₂).

4. The method for manufacturing a lithium secondary battery separator according to claim 1, wherein the coupling agent includes at least one functional group selected from the group consisting of a vinyl group, an epoxy group, a methacryl group, an acryl group, an amino group, a mercapto group and alkyl groups.

5. The method for manufacturing a lithium secondary battery separator according to claim 1, wherein the coupling agent is a silane coupling agent.

6. The method for manufacturing a lithium secondary battery separator according to claim 1, wherein the polymer is an aliphatic polymer.

7. The method for manufacturing a lithium secondary battery separator according to claim 1, wherein the polymer is a polyolefin-based polymer.

8. The method for manufacturing a lithium secondary battery separator according to claim 1, wherein a ketone functional group is formed in the polymer by the electron beam irradiation.

9. The method for manufacturing a lithium secondary battery separator according to claim 1, wherein a covalent bond is formed between the polymer and the inorganic particle by the electron beam irradiation.

10. The method for manufacturing a lithium secondary battery separator according to claim 1, wherein an ester bond is formed between the polymer and the inorganic particle by the electron beam irradiation.

11. The method for manufacturing a lithium secondary battery separator according to claim 1, wherein the electron beam is irradiated with an electron fluence of 5 × 10¹³ cm⁻² to 1 × 10¹⁵ cm⁻².

12. A lithium secondary battery separator prepared by the method of claim 1.

13. A lithium secondary battery comprising the lithium secondary battery separator of claim 12.

14. A method for manufacturing a lithium secondary battery comprising a step of preparing a lithium secondary battery separator according to the method for manufacturing a lithium secondary battery separator of claim 1.
